(19) United States
(12) Patent Application Publication
(10) Pub. No.: US 2025/0002255 A1
(43) Pub. Date: Jan. 2, 2025

(54) Article Sorting Facility

(71) Applicant: Daifuku Co., Ltd., Osaka-shi (JP)

(72) Inventors: Toru Konagaya, Hinocho (JP); Akira Takeuchi, Hinocho (JP)

(21) Appl. No.: 18/755,852

(22) Filed: Jun. 27, 2024

(30) Foreign Application Priority Data
Jun. 29, 2023 (JP) 2023-107402

(51) Int. Cl. B65G 1/137; B65G 1/04

(52) U.S. Cl. CPC B65G 1/1378; B65G 1/0492

(57) ABSTRACT

A floor on which a plurality of transport vehicles travel includes a first supply area, a second supply area, a connection area, a first aisle area including a first outgoing path and a first return path adjacent to the first outgoing path in an X-direction, and a second aisle area including a second outgoing path and a second return path adjacent to the second outgoing path in the X-direction.

### CROSS-REFERENCE TO RELATED APPLICATION

This application claims priority to Japanese Patent Application No. 2023-107402 filed Jun. 29, 2023, the disclosure of which is hereby incorporated by reference in its entirety.

### BACKGROUND OF THE INVENTION

### Field of the Invention

The present invention relates to an article sorting facility in which multiple transport vehicles transport articles.

### Description of Related Art

Article sorting facilities in which multiple transport vehicles transport articles are known. For example, Japanese Unexamined Patent Application Publication No. 2020-100482 (Patent Literature 1) describes an article sorting facility in which transport vehicles (V) traveling on a floor (70) transport articles (W) from a supply unit (90) to receivers (80).

In the article sorting facility described in Patent Literature 1, multiple receiver ports (81) through which articles (W) are received are disposed in a distributed manner. The receiver ports (81) are surrounded by aisles for the transport vehicles (V). When multiple transport vehicles travel, the facility is likely to have many intersections between the travel paths for the respective vehicles and thus involves controlling each transport vehicle (V) to avoid contact with another transport vehicle (V). This increases the frequency of the transport vehicles (V) being stopped, possibly decreasing the efficiency of transporting the articles (W) with the transport vehicle (V).

Article sorting facilities that easily increase the efficiency of transporting articles with multiple transport vehicles are awaited.

### SUMMARY OF THE INVENTION

An article sorting facility according to an aspect of the disclosure is an article sorting facility in which a plurality of transport vehicles travel on a floor and transport articles to sort the articles. The article sorting facility includes a first supply unit and a second supply unit that each supply the articles to the plurality of transport vehicles, and a plurality of receivers that receive the articles from the plurality of transport vehicles. The floor includes a first aisle area extending in a Y-direction as a direction along the floor, a second aisle area disposed on a second side relative to the first aisle area in an X-direction as a direction along the floor and orthogonal to the Y-direction and extending in the Y-direction, a first supply area disposed on a first side relative to the first aisle area and the second aisle area in the Y-direction and including the first supply unit, a second supply area disposed on the first side relative to the first aisle area and the second aisle area in the Y-direction and disposed on the second side relative to the first supply area in the X-direction and including the second supply unit, and a connection area connecting the first aisle area, the second aisle area, the first supply area, and the second supply area to one another. The plurality of receivers include receivers arranged along the first aisle area and receivers arranged along the second aisle area. The first aisle area includes a first outgoing path and a first return path adjacent to the first outgoing path in the X-direction. The first outgoing path is for the plurality of transport vehicles to travel from a first end of the first aisle area on the first side in the Y-direction to a first turn position on a second side relative to the first end in the Y-direction. The first return path is for the plurality of transport vehicles to travel from the first turn position to the first end. The second aisle area includes a second outgoing path and a second return path adjacent to the second outgoing path in the X-direction. The second outgoing path is for the plurality of transport vehicles to travel from a second end of the second aisle area on the first side in the Y-direction to a second turn position on the second side relative to the second end in the Y-direction. The second return path is for the plurality of transport vehicles to travel from the second turn position to the second end.

This structure allows a transport vehicle receiving an article at the first supply unit or the second supply unit to transport the article to one of the multiple receivers arranged along the first aisle area or the second aisle area, thus allowing sorting of articles between the multiple receivers. Additionally, the first aisle area and the second aisle area extending in the Y-direction allow many receivers to be arranged on the periphery of a floor E. Further, each aisle area includes the outgoing path and the return path adjacent to the outgoing path in the X-direction. This allows multiple transport vehicles reciprocating in the aisle area to be less likely to collide with one another. The structure thus easily increases the efficiency of transporting articles with multiple transport vehicles.

### BRIEF DESCRIPTION OF THE DRAWINGS

FIG. 1 is a top view of an article sorting facility according to an embodiment.

FIG. 2 is a diagram of example travel paths for transport vehicles in FIG. 1.

FIG. 3 is a front view of an aisle area in FIG. 1.

FIG. 4 is a control block diagram of the article sorting facility in FIG. 1.

### DESCRIPTION OF THE INVENTION

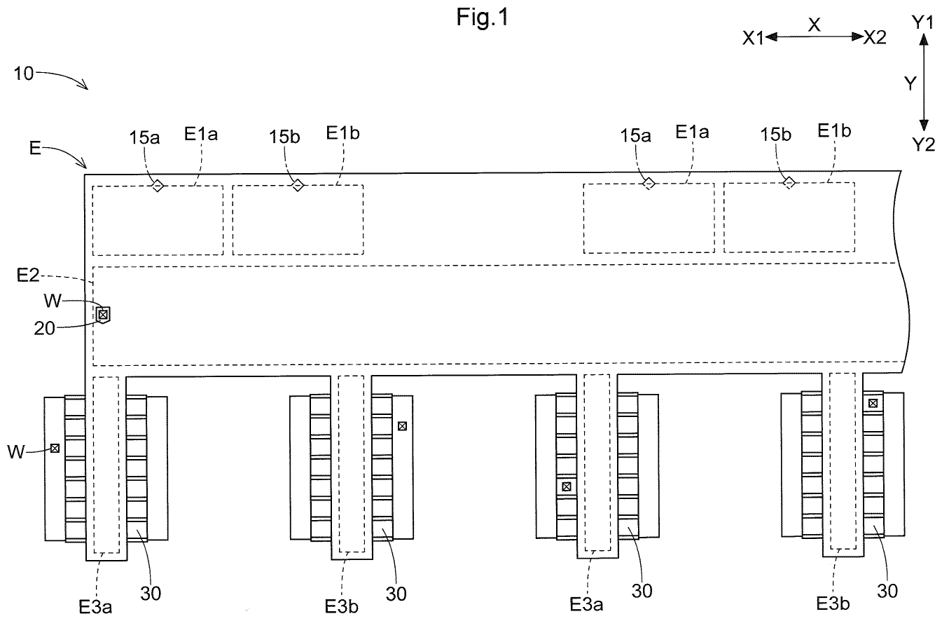

An article sorting facility 10 according to one or more embodiments will now be described with reference to the drawings. FIG. 1 is a top view of the article sorting facility 10. In the article sorting facility 10, multiple transport vehicles 20 travel on a floor E and transport articles W to sort the articles W. The article sorting facility 10 includes first supply units 15a and second supply units 15b each for supplying articles W to the transport vehicles 20. The article sorting facility 10 includes multiple receivers 30 each for receiving the articles W from the transport vehicles 20.

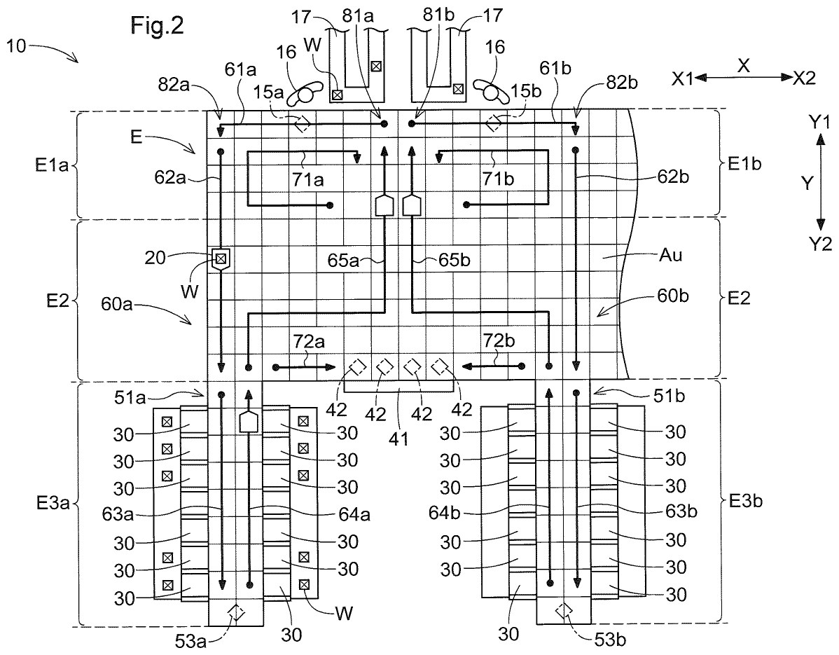

FIG. 2 is a diagram of example travel paths for the transport vehicles 20. In the present embodiment, an operating entity 16 transfers articles W to the transport vehicles 20 at each of the first supply unit 15a and the second supply unit 15b. The operating entity herein refers to, for example, an operator, an operating device, or both. The operating entity 16 transfers articles W from a supply transporter 17 to the transport vehicles 20. The supply transporter 17 transports articles W from an automated warehouse (not shown). Examples of the supply transporter 17 include a belt conveyor, a crane, and a robotic arm.

A specific direction along the floor E is referred to as a Y-direction. A direction perpendicular to the Y-direction and along the floor E is referred to as an X-direction. One side in the Y-direction is referred to as a first side Y1 in the Y-direction, and the other side in the Y-direction is referred to as a second side Y2 in the Y-direction. One side in the X-direction is referred to as a first side X1 in the X-direction, and the other side in the X-direction is referred to as a second side X2 in the X-direction. The direction aligned with the vertical direction is referred to as a Z-direction. Examples of the floor E include transport surfaces on which vehicles travel and floors in buildings, ships, and other facilities. In the present embodiment, the floor E is a transport surface on an indoor platform.

The floor E includes a first supply area Ela including the first supply unit 15a and a second supply area E1b including the second supply unit 15b. The second supply area E1b is disposed on the second side X2 relative to the first supply area Ela in the X-direction. The first supply area Ela and the second supply area E1b are disposed on the first side Y1 relative to a first aisle area E3a and a second aisle area E3b (described later) in the Y-direction.

The floor E includes a first aisle area E3a extending in the Y-direction, and a second aisle area E3b disposed on the second side X2 relative to the first aisle area E3a in the X-direction and extending in the Y-direction. The multiple receivers 30 include receivers 30 arranged along the first aisle area E3a and receivers 30 arranged along the second aisle area E3b.

The floor E includes a connection area E2 connecting the first supply area Ela, the first aisle area E3a, the second supply area E1b, and the second aisle area E3b. The connection area E2 connects a first aisle end 51a (described below), a second aisle end 51b (described below), the first supply area Ela, and the second supply area E1b to one another. The first supply area Ela, the second supply area E1b, the connection area E2, the first aisle area E3a, and the second aisle area E3b on the floor E may each be physically-defined areas or virtually-defined areas. The boundary between the first supply area Ela and the connection area E2 and the boundary between the second supply area E1b and the connection area E2 are virtual boundaries defined on the floor E. The boundary between the first supply area Ela and the second supply area E1b is a virtual boundary (not shown) defined on the floor E. Each of the first aisle area E3a and the second aisle area E3b has, in the X-direction, the opposite ends serving as the outer edges of the floor E.

The first aisle area E3a has the first aisle end 51a on the first side Y1 in the Y-direction. The connection area E2 connects the first aisle end 51a and the first supply area Ela. The connection area E2 connects the first aisle end 51a and the first supply area Ela to allow the transport vehicles 20 to travel between the area and the end. The connection area E2 includes a first connection outgoing path 62a for the transport vehicles 20 to travel from the first supply area Ela toward the first aisle area E3a. The connection area E2 includes a first connection return path 65a for the transport vehicles 20 to travel from the first aisle area E3a toward the first supply area Ela. In the example in the figure, the first connection outgoing path 62a is linear and continuous in the Y-direction.

The second aisle area E3b has the second aisle end 51b on the first side Y1 in the Y-direction. The connection area E2 connects the second aisle end 51b and the second supply area E1b. The connection area E2 connects the second aisle end 51b and the second supply area E1b to allow the transport vehicles 20 to travel between the area and the end. The connection area E2 includes a second connection outgoing path 62b for the transport vehicle 20 to travel from the second supply area E1b toward the second aisle area E3b. The connection area E2 includes a second connection return path 65b for the transport vehicles 20 to travel from the second aisle area E3b toward the second supply area E1b. In the example in the figure, the second connection outgoing path 62b is linear and continuous in the Y-direction.

The first aisle area E3a includes a first outgoing path 63a and a first return path 64a adjacent to the first outgoing path 63a in the X-direction. The first outgoing path 63a allows the transport vehicles 20 to travel from the first aisle end 51a to a first turn position 53a on the second side Y2 relative to the first aisle end 51a in the Y-direction. The first return path 64a allows the transport vehicles 20 to travel from the first turn position 53a to the first aisle end 51a. The first supply area Ela and the first aisle area E3a partially overlap each other as viewed in the Y-direction. The first connection outgoing path 62a and the first outgoing path 63a are linear and continuous in the Y-direction.

The second aisle area E3b includes a second outgoing path 63b and a second return path 64b adjacent to the second outgoing path 63b in the X-direction. The second outgoing path 63b allows the transport vehicles 20 to travel from the second aisle end 51b to a second turn position 53b on the second side Y2 relative to the second aisle end 51b in the Y-direction. The second return path 64b allows the transport vehicles 20 to travel from the second turn position 53b to the second aisle end 51b. The second supply area E1b and the second aisle area E3b partially overlap each other as viewed in the Y-direction. The second connection outgoing path 62b and the second outgoing path 63b are linear and continuous in the Y-direction.

The first return path 64a is disposed on the second side X2 relative to the first outgoing path 63a in the X-direction. The second return path 64b is disposed on the first side X1 relative to the second outgoing path 63b in the X-direction. The first turn position 53a is at the end of the first aisle area E3a on the second side Y2 in the Y-direction. The second turn position 53b is at the end of the second aisle area E3b on the second side Y2 in the Y-direction.

The first supply area Ela includes a first supply path 61a for the transport vehicles 20 to travel in the X-direction from the side on which the first return path 64a is disposed toward the side on which the first outgoing path 63a is disposed. In the example in the figure, the first supply path 61a is defined for the transport vehicles 20 to travel in the X-direction. The first supply unit 15a described above may be disposed at a starting end 81a or a terminal end 82a of the first supply path 61a. In the present embodiment, the first supply unit 15a is disposed in the middle of the first supply path 61a. In other words, the first supply path 61a extends through the first supply unit 15a.

The second supply area E1b includes a second supply path 61b for the transport vehicles 20 to travel in the X-direction from the side on which the second return path 64b is disposed toward the side on which the second outgoing path 63b is disposed. In the example in the figure, the second supply path 61b is defined for the transport vehicles 20 to travel in the X-direction. The second supply unit 15b described above may be disposed at a starting end 81b or a terminal end 82b of the second supply path 61b. In the present embodiment, the second supply unit 15b is disposed in the middle of the second supply path 61b. In other word, the second supply path 61b extends through the second supply unit 15b.

The first supply area Ela includes a first standby path 71a for the transport vehicles 20 to wait before traveling on the first supply path 61a. The first standby path 71a is disposed between the starting end 81a and the terminal end 82a of the first supply path 61a in the X-direction.

The second supply area E1b includes a second standby path 71b for the transport vehicles 20 to wait before traveling on the second supply path 61b. The second standby path 71b is disposed between the starting end 81b and the terminal end 82b of the second supply path 61b in the X-direction.

In the present embodiment, the first aisle area E3a is at a position relative to the first supply area Ela and the first supply unit 15a to have the terminal end of the first supply path 61a disposed on a linear extension of the first outgoing path 63a on the first side Y1 in the Y-direction. In the example in the figure, the terminal end 82a of the first supply path 61a is on a linear extension of the first outgoing path 63a on the first side Y1 in the Y-direction.

In the present embodiment, the second aisle area E3b is at a position relative to the second supply area E1b and the second supply unit 15b to have the terminal end of the second supply path 61b disposed on a linear extension of the second outgoing path 63b on the first side Y1 in the Y-direction. In the example in the figure, the terminal end 82b of the second supply path 61b is on a linear extension of the second outgoing path 63b on the first side Y1 in the Y-direction.

In the present embodiment, the multiple receivers 30 arranged along the first aisle area E3a are adjacent to one another in the Y-direction on the opposite ends of the first aisle area E3a in the X-direction. In the first outgoing path 63a, the transport vehicles 20 transfer articles W to the receivers 30 opposite to the first return path 64a in the X-direction. In the first return path 64a, the transport vehicles 20 transfer articles W to the receivers 30 opposite to the first outgoing path 63a in the X-direction.

In the present embodiment, the multiple receivers 30 arranged along the second aisle area E3b are adjacent to one another in the Y-direction on the opposite ends of the second aisle area E3b in the X-direction. In the second outgoing path 63b, the transport vehicles 20 transfer articles W to the receivers 30 opposite to the second return path 64b in the X-direction. In the second return path 64b, the transport vehicles 20 transfer articles W to the receivers 30 opposite to the second outgoing path 63b in the X-direction.

A travel path 60a for the transport vehicles 20 to travel from the first supply unit 15a and return to the first supply unit 15a is free of intersections. In the present embodiment, a travel path 60a for the transport vehicles 20 to travel from the first supply unit 15a and return to the first supply unit 15a includes no intersection. The travel path 60a includes, in the stated order, the first supply path 61a, the connection area E2, the first outgoing path 63a, the first turn position 53a, the first return path 64a, the connection area E2, and the first supply path 61a. In the example in the figure, the travel path 60a includes the first supply path 61a, the first connection outgoing path 62a, the first outgoing path 63a, the first return path 64a, and the first connection return path 65a. However, the travel path 60a intersects with the travel path for the transport vehicles 20 from the first supply unit 15a to the second aisle area E3b.

A travel path 60b for the transport vehicles 20 to travel from the second supply unit 15b and return to the second supply unit 15b is free of intersections. In the present embodiment, a travel path 60b for the transport vehicles 20 to travel from the second supply unit 15b and return to the second supply unit 15b includes no intersection. The travel path 60b includes, in the stated order, the second supply path 61b, the connection area E2, the second outgoing path 63b, the second turn position 53b, the second return path 64b, the connection area E2, and the second supply path 61b. In the example in the figure, the travel path 60b includes the second supply path 61b, the second connection outgoing path 62b, the second outgoing path 63b, the second return path 64b, and the second connection return path 65b. However, the travel path 60b intersects with the travel path for the transport vehicles 20 from the second supply unit 15b to the first aisle area E3a.

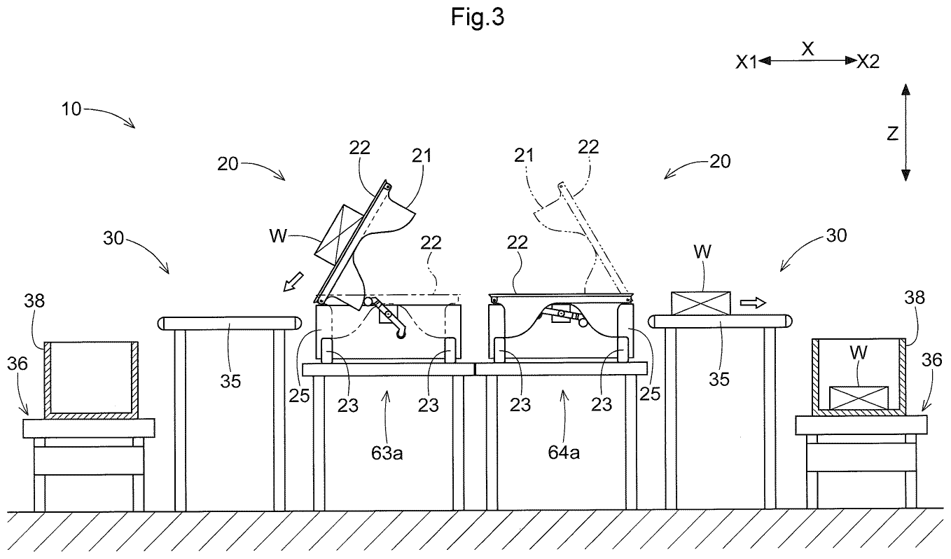

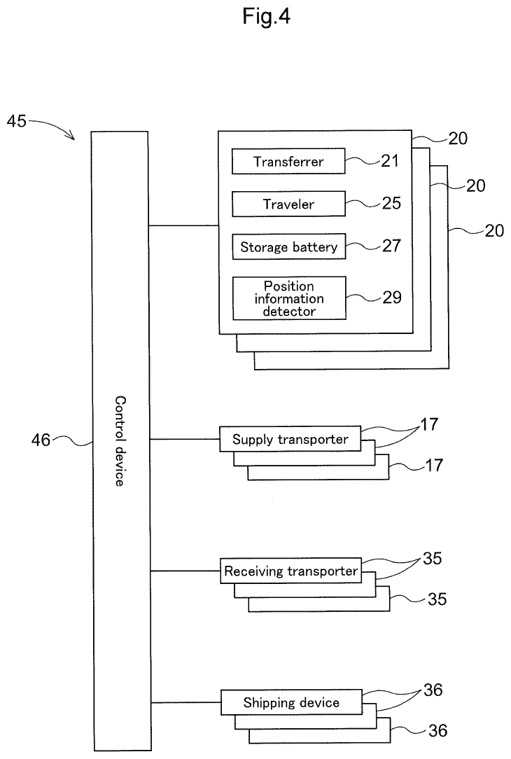

FIG. 3 is a front view of the first aisle area E3a. Each transport vehicle 20 includes a transferrer 21 for transferring an article W from the transport vehicle 20 to a receiver 30. The transferrer 21 has a receiving surface 21a on which an article W is placeable. The receiving surface 21a is switchable between a horizontal orientation and a tilting orientation. While being transported, an article W is placed on the receiving surface 21a in the horizontal orientation. When the receiving surface 21a is in the tilting orientation, the article W is transferred to the receiver 30. Each transport vehicle 20 includes a traveler 25. The traveler 25 includes multiple wheels 23 rolling on the transport surface on the floor E. Examples of the transport vehicles 20 include electric vehicles that travel on electricity supplied from storage batteries or fuel cells, or through contact or contactless power feed from the floor E and include vehicles with internal combustion engines. In the present embodiment, the traveler 25 in each transport vehicle 20 incorporates a storage battery 27 (refer to FIG. 4). The transport vehicles 20 are electric automatic guided vehicles.

Each of the multiple receivers 30 includes a receiving transporter 35. Articles W transferred to the receivers 30 are transported in the X-direction by the respective receiving transporters 35 to be stored in containers 38 for the respective receivers 30. In the present embodiment, the receiving transporters 35 are adjacent to shipping devices 36. The containers 38 are arranged on the shipping devices 36. When articles W of types and quantities specified in one piece of order information are placed in a container 38, the corresponding shipping device 36 transports the container 38 to a shipping location. Examples of the receiving transporters 35 include a belt conveyor, a crane, and a robotic arm. Examples of the shipping devices 36 include a belt conveyor, a stacker crane, and an automatic guided vehicle.

As shown in FIG. 2, a charger 41 for charging the multiple transport vehicles 20 is disposed between the first return paths 64a and second return paths 64b in the X-direction. The charger 41 is adjacent to the connection area E2. The connection area E2 includes charging positions 42 for charging the transport vehicles 20 with the charger 41. The connection area E2 includes charge standby paths 72a and 72b for multiple transport vehicles 20 to wait before being charged by the charger 41. This allows efficient use of the connection area E2, which includes no first supply unit 15a, no second supply unit 15b, or no receivers 30. The charging positions 42 are arranged to allow multiple transport vehicles 20 to stop at the charging positions 42.

Each transport vehicle 20 moves to and stops at a charging position 42 when the remaining battery level is less than a predetermined level (e.g., less than 50% of the full capacity). At the charging position 42, the storage battery 27 in the transport vehicle 20 can be charged rapidly. In the example in the figure, the transport vehicles 20 move from the first connection return path 65a or the second connection return path 65b to stop at the charging positions 42. The fully charged transport vehicles 20 return to the first connection return path 65a or the second connection return path 65b. The charger 41 may be a contactless power feeder or a contact power feeder. In the present embodiment, a control device 46 included in a control system 45 (described later) obtains the remaining level of the storage battery 27 in each transport vehicle 20 and controls any transport vehicle 20 with less than a predetermined battery level to move to a charging position 42.

FIG. 4 is a control block diagram of the article sorting facility 10 according to the present embodiment. Each of the multiple transport vehicles 20 includes a position information detector 29. The travel paths (60a and 60b) for the transport vehicles 20 defined on the floor E include position information holders (not shown) disposed at predetermined intervals. When the transport vehicles 20 travel on the travel paths (60a and 60b), the position information detector 29 in each transport vehicle 20 detects the position information held by the position information holders. Examples of the position information holders include barcodes (one-dimensional codes), two-dimensional codes, and radio-frequency identification tags. The position information detected by the position information detector 29 is transmitted from each transport vehicle 20 to the control device 46 in the control system 45 (described later). The floor E is divided into multiple virtual subareas Au (refer to FIG. 2) in a grid as viewed in the Z-direction. The travel paths for the transport vehicles 20 connect any number of virtual subareas Au to one another. The position information holders are disposed in, for example, the respective virtual subareas Au.

The article sorting facility 10 includes the control system 45 to control the transport vehicles 20. The control system 45 includes the control device 46 to control the transferrers 21 and the travelers 25 in the transport vehicles 20. The control device 46 includes an arithmetic processor such as a central processing unit (CPU) and a main storage such as a random-access memory (RAM) or a read-only memory (ROM) that can be referenced by the arithmetic processor.

The functions of the control device 46 (e.g., the function of controlling the travel of the transport vehicles 20) are implemented by the hardware in the control device 46 cooperating with a program executed on the arithmetic processor or other pieces of hardware. More specifically, each function of the control device 46 is implemented by the control device 46 executing a program stored in a storage (e.g., the main storage or a storage separate from the main storage). In other words, the program (e.g., an article sorting program) for causing a computer (a computer in the control system 45) to implement the functions of the control device 46 is stored in a storage that can be referenced by the computer. The program is provided by, for example, a storage medium or through a communication network. The provided program is then stored into a storage that can be referenced by the computer. In the present embodiment, the control device 46 (specifically, the arithmetic processor in the control device 46) functions as the computer. The control device 46 may be a set of multiple pieces of hardware (multiple separate pieces of hardware) that can communicate with one another through wires or wirelessly, rather than a single piece of hardware. For example, the control device 46 may include a host controller disposed in a control facility (not shown) to control the transport vehicles 20 and controllers mounted on the respective transport vehicles 20.

The control system 45 provides, for example, transport commands to each transport vehicle 20. The transport command specifies the source and the destination of an article W. In the present embodiment, the source is one of the supply units 15. The destination is one of the receivers 30. The transport command specifies the travel path for the transport vehicle 20 to use from the source to the destination. Upon receiving the transport command from the control system 45, the transport vehicle 20 receives an article W at the specified source and transports the article W to the specified destination.

Referring back to FIG. 1, multiple unit area groups each including the first aisle area E3a, the second aisle area E3b, the first supply area Ela, and the second supply area E1b are connected to one another by the connection area E2. In this structure, the transport vehicles 20 can transport articles W from many supply units (such as the first supply units 15a and the second supply units 15b) to many receivers 30 to sort the articles W. For example, the transport vehicles 20 can transport articles W from a supply unit (a first supply unit 15a or a second supply unit 15b) to the receivers 30 along an aisle area (a first aisle area E3a or a second aisle area E3b) in a unit area group different from a unit area group including the supply unit to sort the articles W. In the present embodiment, the transport vehicles 20 can transport articles W from the first supply unit 15a in the first supply area Ela to the receivers 30 along the second aisle area E3b to sort the articles W. The transport vehicle 20 can transport articles W from the second supply unit 15b in the second supply area E1b to the receivers 30 along the first aisle area E3a to sort the articles W.

Article sorting facilities 10 according to other embodiments will now be described.

(1) In the embodiment described above, the first return path 64a is disposed on the second side X2 relative to the first outgoing path 63a in the X-direction, and the second return path 64b is disposed on the first side X1 relative to the second outgoing path 63b in the X-direction. However, the structure is not limited to such an example. For example, the first outgoing path 63a may be disposed on the second side X2 relative to the first return path 64a in the X-direction, and the second return path 64b may be disposed on the first side X1 relative to the second outgoing path 63b in the X-direction. For example, the first return path 64a and the first connection return path 65a may be disposed on the first side X1 relative to the first outgoing path 63a and the first connection outgoing path 62a in the X-direction, and the second return path 64b and the second connection return path 65b may be disposed on the second side X2 relative to the second outgoing path 63b and the second connection outgoing path 62b in the X-direction.

(2) In the embodiment described above, the charger 41 for charging the multiple transport vehicles 20 is adjacent to the connection area E2. However, the structure is not limited to such an example. For example, the charger 41 may be disposed in the connection area E2 or adjacent to, for example, the first supply area Ela. For example, the article sorting facility 10 may not include the charger 41.

(3) In the embodiment described above, the multiple receivers 30 include the receivers 30 disposed on the opposite ends of the first aisle area E3a in the X-direction and the receivers 30 disposed on the opposite ends of the second aisle area E3b in the X-direction, and each turn position (the first turn position 53a or the second turn position 53b) is defined at the end of the corresponding one of the first aisle area E3a or the second aisle area E3b on the second side Y2 in the Y-direction. However, the structure is not limited to such an example. For example, the receivers 30 may be disposed on one end of the first aisle area E3a alone in the X-direction. For example, the receivers 30 may be disposed on one end of the second aisle area E3b alone in the X-direction. For example, the first turn position 53a may be disposed in the middle of the first aisle area E3a. For example, the second aisle area E3b may be disposed in the middle of the second aisle area E3b.

(4) In the embodiment described above, the travel path 60a for the transport vehicles 20 is free of intersections, and the travel path 60b for the transport vehicles 20 includes is free of intersections. However, the structure is not limited to such an example. For example, the travel path 60a or the travel path 60b may include intersections. For example, the first connection outgoing path 62a, the first connection return path 65a, the second connection outgoing path 62b, and the second connection return path 65b may overlap one another. For example, the travel path 60a may include the charge standby path 72a. For example, the travel path 60b may include the charge standby path 72b. For example, the travel path 60a and the travel path 60b may not include position information holders. The position information about the transport vehicles 20 may be obtained by, for example, image sensors installed in the transport vehicles 20 or the facility.

(5) In the embodiment described above, the first supply area Ela, the second supply area E1b, and the connection area E2 are defined by virtual boundaries, and the opposite ends of each of the first aisle area E3a and the second aisle area E3b in the X-direction serve as the outer edges of the floor E. However, the structure is not limited to such an example. For example, the first supply area Ela, the second supply area E1b, the connection area E2, the first aisle area E3a, and the second aisle area E3b may each be defined by the physical outer edge of the floor E and may each be an area in which the transport vehicles 20 are movable. For example, the first supply area Ela and the second supply area E1b may not be adjacent to each other. For example, the first supply area Ela, the second supply area E1b, the connection area E2, the first aisle area E3a, and the second aisle area E3b may all be virtual areas defined on the large floor E. For example, the floor E may include areas other than the first supply area Ela, the second supply area E1b, the connection area E2, the first aisle area E3a, and the second aisle area E3b. For example, the floor E may include a buffer area in which multiple transport vehicles 20 can be in line.

(6) In the embodiment described above, the first supply area Ela and the first aisle area E3a partially overlap each other as viewed in the Y-direction, and the second supply area E1b and the second aisle area E3b partially overlap each other as viewed in the Y-direction. The connection area E2 connects the areas to allow the transport vehicles 20 to travel between the areas. However, the structure is not limited to such an example. For example, the first supply area Ela and the first aisle area E3a may have no overlap portion as viewed in the Y-direction, and the first connection outgoing path 62a and the first outgoing path 63a may not be linear and continuous with each other. For example, the second supply area E1b and the second aisle area E3b may have no overlap portion as viewed in the Y-direction, and the second connection outgoing path 62b and the second outgoing path 63b may not be linear and continuous with each other. For example, the connection area E2 may connect the first supply area Ela and the first aisle area E3a not to allow travel of the transport vehicles 20 between the areas. The transport vehicles 20 may be transferred by a transfer device between the first supply area Ela and the connection area E2 and between the first aisle area E3a and the connection area E2. For example, the connection area E2 may connect the second supply area E1b and the second aisle area E3b not to allow travel of the transport vehicles 20 between the areas. The transport vehicles 20 may be transferred by a transfer device between the second supply area E1b and the connection area E2 and between the second aisle area E3b and the connection area E2.

(7) In the embodiment described above, the first supply path 61a and the second supply path 61b are defined to allow the transport vehicles 20 to travel in the X-direction. However, the structure is not limited to such an example. For example, the first supply path 61a and the second supply path 61b may be defined to allow the transport vehicles 20 to travel in a direction intersecting with the X-direction. For example, the first supply path 61a may be defined to allow the transport vehicles 20 to travel in the X-direction from the side on which the first outgoing path 63a is disposed toward the side on which the first return path 64a is disposed. For example, the second supply path 61b may be defined to allow the transport vehicles 20 to travel in the X-direction from the side on which the second outgoing path 63b is disposed toward the side on which the second return path 64b is disposed.

(8) In the embodiment described above, the terminal end 82a of the first supply path 61a is on a linear extension of the first outgoing path 63a on the first side Y1 in the Y-direction, and the terminal end 82b of the second supply path 61b is on a linear extension of the second outgoing path 63b on the first side Y1 in the Y-direction. However, the structure is not limited to such an example. For example, the terminal end 82a of the first supply path 61a may not be on the linear extension of the first outgoing path 63a on the first side Y1 in the Y-direction. For example, the terminal end 82b of the second supply path 61b may not be on the linear extension of the second outgoing path 63b on the first side Y1 in the Y-direction.

(9) In the embodiment described above, the first standby path 71a is disposed between the starting end 81a and the terminal end 82a of the first supply path 61a in the X-direction, and the second standby path 71b is disposed between the starting end 81b and the terminal end 82b of the second supply path 61b in the X-direction. However, the structure is not limited to such an example. The first standby path 71a may be disposed on the second side X2 relative to the starting end 81a of the first supply path 61a in the X-direction. For example, the second standby path 71b may be disposed on the second side X2 relative to the terminal end 82b of the second supply path 61b in the X-direction. For example, the first standby path 71a and the second standby path 71b may be disposed in the connection area E2. For example, the first standby path 71a and the second standby path 71b may not be defined.

(10) In the embodiment described above, the article sorting facility 10 includes multiple unit area groups. However, the structure is not limited to such an example. For example, the article sorting facility 10 may include a single unit area group.

(11) In the embodiment described above, the control system 45 includes a host controller that controls the multiple transport vehicles 20 and controllers mounted on the respective transport vehicles 20. However, the structure is not limited to such an example. For example, the control system 45 may be a system in which the controller on each transport vehicle 20 communicates with the controller on another transport vehicle 20 to autonomously determine the operation.

(12) In the embodiment described above, the control system 45 controls the transferrer 21 and the traveler 25 in each transport vehicle 20. However, the structure is not limited to such an example. For example, the control device 46 may control the traveler 25 in each transport vehicle 20 alone. For example, each transport vehicle 20 may not include the transferrer 21, and the operating entities 16 may transfer articles W on the transport vehicles 20. For example, articles W may be stored in compartments included in the transport vehicles 20. For example, the control system 45 may control the operation devices, which are the operating entities 16.

(13) In the embodiment described above, the article sorting facility 10 includes the supply transporters 17, the receiving transporters 35, and the shipping devices 36. However, the structure is not limited to such an example. For example, the article sorting facility 10 may not include the supply transporters 17, the receiving transporters 35, and the shipping devices 36. Operators or vehicles operated by operators may transport articles W or the containers 38.

(14) In the embodiment described above, the first supply area Ela includes the first supply path 61a, and the second supply area E1b includes the second supply path 61b. However, the structure is not limited to such an example. For example, the supply path 61a or the second supply path 61b may be defined to allow the transport vehicles 20 to reciprocate in the Y-direction. For example, the first supply path 61a may be defined to allow the transport vehicles 20 to travel in the X-direction from the side on which the first outgoing path 63a is disposed toward the side on which the first return path 64a is disposed. For example, the second supply path 61b may be defined to allow the transport vehicles 20 to travel in the X-direction from the side on which the second outgoing path 63b is disposed toward the side on which the second return path 64b is disposed.

(15) The structures described in the above embodiments may be combined with those in the other embodiments unless any contradiction arises. For other structures as well, the embodiments described herein are mere examples in all aspects. The embodiments may thus be modified variously as appropriate without departing from the spirit and scope of the disclosure.

The article sorting facility according to one or more embodiments of the disclosure will be described below.

An article sorting facility according to one aspect is an article sorting facility in which a plurality of transport vehicles travel on a floor and transport articles to sort the articles. The article sorting facility includes a first supply unit and a second supply unit that each supply the articles to the plurality of transport vehicles, and a plurality of receivers that receive the articles from the plurality of transport vehicles. The floor includes a first aisle area extending in a Y-direction as a direction along the floor, a second aisle area disposed on a second side relative to the first aisle area in an X-direction as a direction along the floor and orthogonal to the Y-direction and extending in the Y-direction, a first supply area disposed on a first side relative to the first aisle area and the second aisle area in the Y-direction and including the first supply unit, a second supply area disposed on the first side relative to the first aisle area and the second aisle area in the Y-direction and disposed on the second side relative to the first supply area in the X-direction and including the second supply unit, and a connection area connecting a first path end being an end of the first aisle area on the first side in the Y-direction, a second path end being an end of the second aisle area on the first side in the Y-direction, the first supply area, and the second supply area to one another. The plurality of receivers include receivers arranged along the first aisle area and receivers arranged along the second aisle area. The first aisle area includes a first outgoing path and a first return path adjacent to the first outgoing path in the X-direction. The first outgoing path is for the plurality of transport vehicles to travel from a first end of the first aisle area on the first side in the Y-direction to a first turn position on a second side relative to the first end in the Y-direction. The first return path is for the plurality of transport vehicles to travel from the first turn position to the first end. The second aisle area includes a second outgoing path and a second return path adjacent to the second outgoing path in the X-direction. The second outgoing path is for the plurality of transport vehicles to travel from a second end of the second aisle area on the first side in the Y-direction to a second turn position on the second side relative to the second end in the Y-direction. The second return path is for the plurality of transport vehicles to travel from the second turn position to the second end.

This structure allows a transport vehicle receiving an article at the first supply unit or the second supply unit to transport the article to one of the multiple receivers arranged along the first aisle area or the second aisle area, thus allowing sorting of articles between the multiple receivers. Additionally, the first aisle area and the second aisle area extending in the Y-direction allow many receivers to be arranged on the periphery of the floor E and allows sorted articles to be moved from the receivers without through the floor E. This allows the sorting facility to easily have a simplified structure. Further, each aisle area includes the outgoing path and the return path adjacent to the outgoing path in the X-direction. This allows multiple transport vehicles reciprocating in the aisle area to be less likely to collide with one another. The structure thus easily increases the efficiency of transporting articles with multiple transport vehicles.

In one aspect, the first supply area includes a first supply path for the plurality of transport vehicles to travel in the X-direction from a side on which the first return path is disposed toward a side on which the first outgoing path is disposed, and the second supply area includes a second supply path for the plurality of transport vehicles to travel in the X-direction from a side on which the second return path is disposed toward a side on which the second outgoing path is disposed.

This structure easily prevents the travel path for the transport vehicles from the first supply unit to the first outgoing path in the first aisle area from intersecting with the travel path for the transport vehicles from the first return path to the first supply unit. This structure also easily prevents the travel path for the transport vehicles from the second supply unit to the second outgoing path in the second aisle area from intersecting with the travel path for the transport vehicles from the second return path to the second supply unit. This reduces the likelihood that a transport vehicle stops to avoid contact with another transport vehicle at an intersection between the travel paths. The structure thus easily increases the efficiency of transporting articles with multiple transport vehicles between the first supply unit and the multiple receivers or between the second supply unit and the multiple receivers.

In one aspect, a first travel path for the plurality of transport vehicles to travel from the first supply unit and return to the first supply unit is free of intersections. The first travel path includes, in the stated order, the first supply path, the connection area, the first outgoing path, the first turn position, the first return path, the connection area, and the first supply path. A second travel path for the plurality of transport vehicles to travel from the second supply unit and return to the second supply unit is free of intersections. The second travel path includes, in the stated order, the second supply path, the connection area, the second outgoing path, the second turn position, the second return path, the connection area, and the second supply path.

In this structure, the travel path for the transport vehicles to travel from the first supply unit and return to the first supply unit through the first aisle area is free of intersections, and the travel path for the transport vehicles to travel from the second supply unit and return to the second supply unit through the second aisle area is free of intersections. This reduces the likelihood that a transport vehicle stops to avoid contact with another transport vehicle at an intersection in each travel path. The structure thus easily increases the efficiency of transporting articles with multiple transport vehicles between the first supply unit and the multiple receivers or between the second supply unit and the multiple receivers.

In one aspect, the first aisle area is at a position relative to the first supply area and the first supply unit to have a terminal end of the first supply path disposed on a linear extension of the first outgoing path toward the first side in the Y-direction, and the second aisle area is at a position relative to the second supply area and the second supply unit to have a terminal end of the second supply path disposed on a linear extension of the second outgoing path toward the first side in the Y-direction.

This structure allows the first aisle area to have the shortest distance from the terminal end of the first supply path, and allows the second aisle area to have the shortest distance from the terminal end of the second supply path. The transport vehicles that have received articles are thus more likely to travel shorter distances to the receivers. The structure thus easily increases the efficiency of transporting articles with multiple transport vehicles between the first supply unit and the multiple receivers or between the second supply unit and the multiple receivers.

In one aspect, the first supply area includes a first standby path for the plurality of transport vehicles to wait before traveling on the first supply path, the second supply area includes a second standby path for the plurality of transport vehicles to wait before traveling on the second supply path, the first standby path is between a starting end and a terminal end of the first supply path in the X-direction, and the second standby path is between a starting end and a terminal end of the second supply path in the X-direction.

In this structure, the first standby path can be defined using an area between the travel path for the transport vehicles extending from the terminal end of the first supply path toward the first path and the travel path for the transport vehicles extending from the first aisle area toward the starting end of the first supply path. The second standby path can be defined using an area between the travel path for the transport vehicles extending from the terminal end of the second supply path toward the second aisle area and the travel path for the transport vehicles extending from the second aisle area toward the starting end of the second supply path. The unused area in the floor can be used effectively to define the standby path for the transport vehicles.

In one aspect, the first return path is disposed on the second side relative to the first outgoing path in the X-direction, and the second return path is disposed on a first side relative to the second outgoing path in the X-direction. The article sorting facility includes a charger disposed between the first return path and the second return path in the X-direction to charge the plurality of transport vehicles.

This structure allows an unloaded transport vehicle after transferring the article to a receiver to use a path not intersecting with a path for another transport vehicle when the unloaded transport vehicle moves to the charger for charging.

In one aspect, the receivers arranged along the first aisle area are adjacent to one another in the Y-direction on opposite ends of the first aisle area in the X-direction, and the receivers arranged along the second aisle area are adjacent to one another in the Y-direction on opposite ends of the second aisle area in the X-direction. The plurality of transport vehicles transfer, in the first outgoing path, the articles to the receivers opposite to the first return path in the X-direction, transfer, in the first return path, the articles to the receivers opposite to the first outgoing path in the X-direction, transfer, in the second outgoing path, the articles to the receivers opposite to the second return path in the X-direction, and transfer, in the second return path, the articles to the receivers opposite to the second outgoing path in the X-direction.

This structure allows transfer of articles to the receivers along both the outgoing path and the return path in each of the first aisle area and the second aisle area. This allows efficient sorting of articles between many receivers in a limited number of aisle areas.

The article sorting facility according to one or more embodiments of the disclosure may produce at least one of the above advantageous effects.

What is claimed is:

1. An article sorting facility in which a plurality of transport vehicles travel on a floor and transport articles to sort the articles, the article sorting facility comprising:
a first supply unit and a second supply unit each configured to supply the articles to the plurality of transport vehicles; and
a plurality of receivers configured to receive the articles from the plurality of transport vehicles, and
wherein:
the floor comprises:
a first aisle area extending in a Y-direction as a direction along the floor
a second aisle area disposed on a second side relative to the first aisle area in an X-direction as a direction along the floor and orthogonal to the Y-direction, the second aisle area extending in the Y-direction,
a first supply area disposed on a first side relative to the first aisle area and the second aisle area in the Y-direction, the first supply area including the first supply unit,
a second supply area disposed on the first side relative to the first aisle area and the second aisle area in the Y-direction and disposed on the second side relative to the first supply area in the X-direction, the second supply area including the second supply unit, and
a connection area connecting the first aisle area, the second aisle area, the first supply area, and the second supply area to one another,
the plurality of receivers comprises receivers arranged along the first aisle area and receivers arranged along the second aisle area,
the first aisle area comprises a first outgoing path and a first return path adjacent to the first outgoing path in the X-direction, the first outgoing path is for the plurality of transport vehicles to travel from a first end of the first aisle area on the first side in the Y-direction to a first turn position on a second side relative to the first end in the Y-direction, the first return path is for the plurality of transport vehicles to travel from the first turn position to the first end, and
the second aisle area comprises a second outgoing path and a second return path adjacent to the second outgoing path in the X-direction, the second outgoing path is for the plurality of transport vehicles to travel from a second end of the second aisle area on the first side in the Y-direction to a second turn position on the second side relative to the second end in the Y-direction, the second return path is for the plurality of transport vehicles to travel from the second turn position to the second end.

2. The article sorting facility according to claim 1, wherein:
the first supply area comprises a first supply path for the plurality of transport vehicles to travel in the X-direction from a side on which the first return path is disposed toward a side on which the first outgoing path is disposed, and
the second supply area comprises a second supply path for the plurality of transport vehicles to travel in the X-direction from a side on which the second return path is disposed toward a side on which the second outgoing path is disposed.

3. The article sorting facility according to claim 2, wherein:
a first travel path for the plurality of transport vehicles to travel from the first supply unit and return to the first supply unit is free of intersections, and the first travel path comprises, in a stated order, the first supply path, the connection area, the first outgoing path, the first turn position, the first return path, the connection area, and the first supply path, and
a second travel path for the plurality of transport vehicles to travel from the second supply unit and return to the second supply unit is free of intersections, and the second travel path comprises, in a stated order, the second supply path, the connection area, the second outgoing path, the second turn position, the second return path, the connection area, and the second supply path.

4. The article sorting facility according to claim 2, wherein:
the first aisle area is at a position relative to the first supply area and the first supply unit to have a terminal end of the first supply path disposed on a linear extension of the first outgoing path toward the first side in the Y-direction, and
the second aisle area is at a position relative to the second supply area and the second supply unit to have a terminal end of the second supply path disposed on a linear extension of the second outgoing path toward the first side in the Y-direction.

5. The article sorting facility according to claim 2, wherein:
the first supply area comprises a first standby path for the plurality of transport vehicles to wait before traveling on the first supply path,
the second supply area comprises a second standby path for the plurality of transport vehicles to wait before traveling on the second supply path,
the first standby path is between a starting end and a terminal end of the first supply path in the X-direction, and
the second standby path is between a starting end and a terminal end of the second supply path in the X-direction.

6. The article sorting facility according to claim 1, wherein:
the first return path is disposed on the second side relative to the first outgoing path in the X-direction, and the second return path is disposed on a first side relative to the second outgoing path in the X-direction, and
the article sorting facility comprises a charger disposed between the first return path and the second return path in the X-direction to charge the plurality of transport vehicles.

7. The article sorting facility according to claim 1, wherein:
the receivers arranged along the first aisle area are adjacent to one another in the Y-direction on opposite ends of the first aisle area in the X-direction,
the receivers arranged along the second aisle area are adjacent to one another in the Y-direction on opposite ends of the second aisle area in the X-direction, and
the plurality of transport vehicles transfer, in the first outgoing path, the articles to the receivers opposite to the first return path in the X-direction, transfer, in the first return path, the articles to the receivers opposite to the first outgoing path in the X-direction, transfer, in the second outgoing path, the articles to the receivers opposite to the second return path in the X-direction, and transfer, in the second return path, the articles to the receivers opposite to the second outgoing path in the X-direction.
